(19) United States
(12) Patent Application Publication
(10) Pub. No.: US 2026/0025337 A1
(43) Pub. Date: Jan. 22, 2026

(54) ELECTRONIC DEVICE AND METHOD FOR PROCESSING DATA PACKET THEREOF

(71) Applicant: Samsung Electronics Co., Ltd., Suwon-si (KR)

(72) Inventors: Hansung LEEM, Suwon-si (KR); Wonbo LEE, Suwon-si (KR); Hyunsoo KIM, Suwon-si (KR)

(21) Appl. No.: 19/273,445

(22) Filed: Jul. 18, 2025

Related U.S. Application Data
(63) Continuation of application No. PCT/KR2025/010379, filed on Jul. 15, 2025.

(30) Foreign Application Priority Data
Jul. 22, 2024 (KR) 10-2024-0096638
Aug. 28, 2024 (KR) 10-2024-0116190

(51) Int. Cl. H04L 47/2425; H04L 47/193

(52) U.S. Cl. CPC H04L 47/2425; H04L 47/193

(57) ABSTRACT

An electronic device may include a communication circuit, a memory, and at least one processor. The memory may store instructions that cause the electronic device to execute an application, determine a property of the application, receive a plurality of data packets for the application from an external device through the communication circuit, determine whether at least one of data throughput information on the external device, state information about a channel transmitting the plurality of data packets, or signal round trip time information satisfies a specified condition, apply artificial intelligence learning-based algorithms to merge and process the plurality of data packets to the plurality of data packets, based on the specified condition being satisfied, and refrain from applying the artificial intelligence learning-based algorithms to the plurality of data packets, based on the specified condition not being satisfied.

### CROSS-REFERENCE TO RELATED APPLICATIONS

This application is a continuation of International Application No. PCT/KR2025/010379 designating the United States, filed on Jul. 15, 2025, in the Korean Intellectual Property Receiving Office and claiming priority to Korean Patent Application Nos. 10-2024-0096638, filed on Jul. 22, 2024, and 10-2024-0116190, filed on Aug. 28, 2024, in the Korean Intellectual Property Office, the disclosures of each of which are incorporated by reference herein in their entireties.

### BACKGROUND

### Field

The disclosure relates to an electronic device and a method for processing a data packet thereof.

### Description of Related Art

As network data speeds become increasingly faster and speeds of one gigabit or more per second (1 Gbps) become possible, processing data in packet units at a terminal on a receiving side places a significant burden on a central processing unit (CPU). In this case, transmission control protocol (TCP) offload engine (TOE) may be used. TCP offload engine (TOE) is a technology used in Network Interface Cards (NIC) that offloads the TCP/IP (Internet protocol) stack processed on an operating system to a network controller for processing. Generic receive offload (GRO) is a software technology used on the receiving side among TOE technologies, and a technology that reduces the processing load of the TCP (UDP)/IP protocol stack by pre-bundling several consecutive packets of the same session into a single header when processing received packets.

### SUMMARY

An electronic device according to an example embodiment may include: a communication circuit, memory, and at least one processor including processing circuitry. The memory may store instructions that, when individually or collectively executed by the at least one processor, cause the electronic device to execute an application, determine a property of the application, receive a plurality of data packets for the application from an external device through the communication circuit, determine whether at least one of data throughput information on the external device, state information about a channel transmitting the plurality of data packets, or signal round-trip time information satisfies a specified condition, apply artificial intelligence learning-based algorithms to merge and process the plurality of data packets to the plurality of data packets, based on the specified condition being satisfied, and refrain from applying the artificial intelligence learning-based algorithms to the plurality of data packets, based on the specified condition not being satisfied.

An electronic device according to an example embodiment may include: a communication circuit, a memory, and at least one processor including processing circuitry. The memory may store instructions, when individually or collectively executed by the at least one processor, cause the electronic device to execute an application, receive a plurality of data packets for the application from an external device through the communication circuit, check whether a flag set in the plurality of data packets and has a specified value related to merging of the data packets, during a specified period, check a property of the application, apply, to the data packets, a first algorithm to merge and process at least some of the data packets before receiving a data packet corresponding to the flag having the specified value among the data packets, based on the application having a first property, and apply, to the data packets, a second algorithm to merge and process the received data packets until the specified period ends, based on the application not having the first property.

A method for processing a data packet according to an example embodiment may be performed in an electronic device. The method may include: executing an application, receiving a plurality of data packets for the application from an external device through the communication circuit, checking a flag set in the plurality of data packets and having a specified value related to merging of the data packets, during a specified period, checking a property of the application, applying, to the data packets, a first algorithm to merge and process at least some of the data packets before receiving a data packet corresponding to the flag having the specified value among the data packets, based on the application having a first property, and applying, to the data packets, a second algorithm to merge and process the received data packets until the specified period ends, based on the application not having the first property.

A non-transitory computer-readable storage medium according to an example embodiment may store instructions executable by a processor. The instructions, when executed by at least one processor, comprising processing circuitry, individually and/or collectively, of an electronic device cause the electronic device to performs operations comprising: executing an application, receiving a plurality of data packets for the application from an external device through the communication circuit, checking a flag set in the plurality of data packets and having a specified value related to merging of the data packets, during a specified period, checking a property of the application, applying, to the data packets, a first algorithm to merge and process at least some of the data packets before receiving a data packet corresponding to the flag having the specified value among the data packets, based on the application having a first property, and applying, to the data packets, a second algorithm to merge and process the received data packets until the specified period ends, based on the application not having the first property.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of a processor of an electronic device according to various embodiments;

FIG. 3 is a network configuration diagram of an example electronic device according to various embodiments;

FIG. 4 is a diagram illustrating an example AI model for data packet processing according to various embodiments;

FIGS. 5A and 5B are flowcharts illustrating an example method for processing a data packet according to various embodiments;

FIG. 6 is a flowchart illustrating prerequisites for application of an AI algorithm according to various embodiments;

FIG. 7 is a flowchart illustrating an example method for processing a data packet reflecting a white list or a traffic pattern according to various embodiments;

FIGS. 8A, 8B and 8C are graphs illustrating changes in communication performance according to application of a first algorithm or a second algorithm according to various embodiments.

With respect to the description of the drawings, the same or similar reference signs may be used for the same or similar elements.

### DETAILED DESCRIPTION

Hereinafter, various example embodiments of the present disclosure will be described with reference to the accompanying drawings. However, this is not intended to limit the present disclosure to the specific embodiments, and it is to be understood to include various modifications, equivalents, and/or alternatives of embodiments of the present disclosure. With regard to the description of the drawings, similar reference numerals may be used to refer to similar elements.

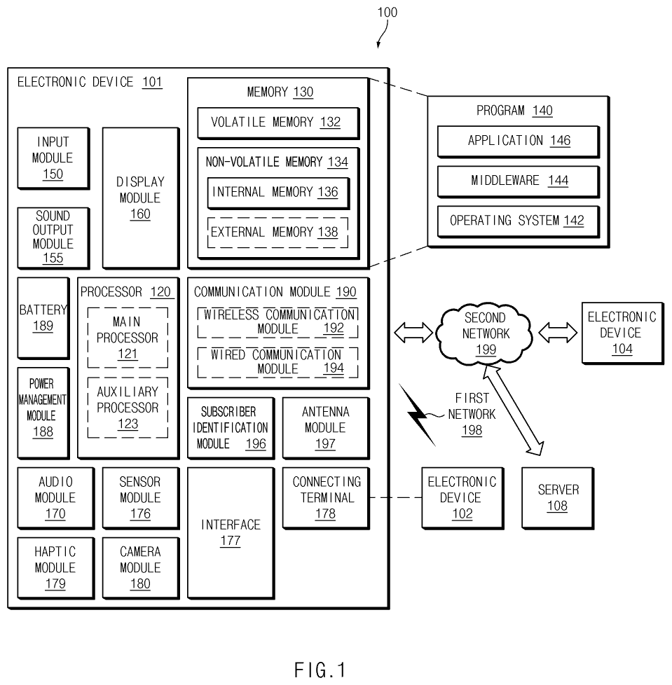

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

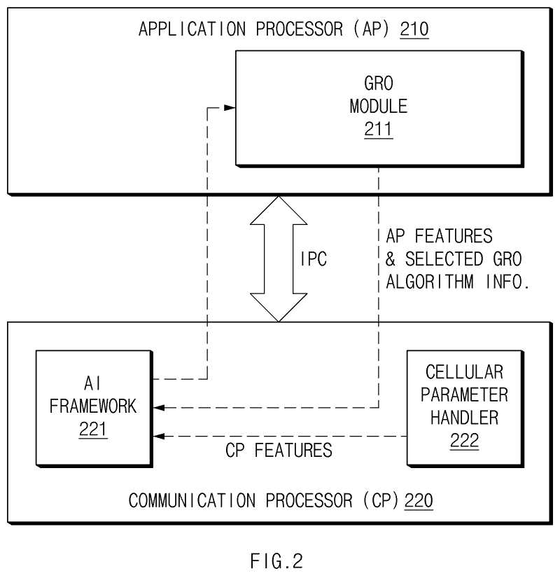

FIG. 2 is a block diagram illustrating an example configuration of a processor of an electronic device according to various embodiments.

Referring to FIG. 2, an electronic device 201 may include an application processor (e.g., including processing circuitry) 210 and a communication processor (e.g., including processing circuitry) 220. The application processor 210 and the communication processor 220 may be two processors that are each separated in terms of hardware. The application processor 210 and the communication processor 220 may be separate processing units within a single processor.

The configuration included in the application processor 210 and the communication processor 220 is an example and is not limited thereto. In addition, regarding merging processing for data packets, at least some of operations or functions performed by the application processor 210 may be performed by the communication processor 220. At least some of operations or functions performed by the communication processor 220 may be performed by the application processor 210.

The application processor 210 and the communication processor 220 may generate an AI-based algorithm (hereinafter, AI algorithm) in relation to merging of data packets. The application processor 210 and the communication processor 220 may use the AI algorithm to determine an aggregation level of data packets according to various conditions related to the application that is being executed. In this way, the electronic device 201 may lower a CPU usage rate and increase the downlink data rate (throughput (TP)).

According to an embodiment, the application processor 210 may include a generic receive offload (GRO) module (e.g., including various circuitry and/or executable program instructions) 211. The GRO module 211 may collect features (e.g., the CPU usage and session number) of the application processor 210 related to GRO (hereinafter, AP features). The GRO module 211 may check a TCP Push flag of the data packet, check the traffic pattern, and determine the algorithm to be applied to the GRO. The GRO module 211 may transmit the AP features and the selected GRO algorithm to the communication processor 220.

According to an embodiment, the application processor 210 may transmit the AP features and determined algorithm information to the communication processor 220 through a specified communication method (e.g., inter-process communication (IPC)).

According to an embodiment, the communication processor 220 may include an AI framework 221 and/or a cellular parameter handler 222.

According to an embodiment, the AI framework 221 may receive the AP features (e.g., the CPU usage and session number) from the application processor 210. The AI framework 221 may receive features (e.g., RSRP, RSSI, PB, MCS, or BLER) (hereinafter, CP features) of the communication processor 220 related to the GRO from the cellular parameter handler 222.

According to an embodiment, the AI framework 221 may calculate a merging period of data packets by passing the AP features collected from the GRO module 211 and the CP features collected from the cellular parameter handler 222 through an AI network. The AI framework 221 may transmit the calculated merging period (GRO flush time) of data packets to the application processor 210.

According to an embodiment, the application processor 210 may operate the GRO algorithm based on the merging period (GRO flush time) of data packets calculated in the communication processor 220.

FIG. 2 is simply an example and the disclosure is not limited thereto. For example, the AI framework may be included in the application processor 210. In this case, the CP features may be transmitted to the application processor 210. The application processor 210 may calculate the merging period of data packets by passing the AP features and CP features through the AI network. The application processor 210 may operate the GRO algorithm based on the calculated merging period (GRO flush time) of data packets.

Operation of a processor 120 described below may be performed by the application processor 210 and/or the communication processor 220.

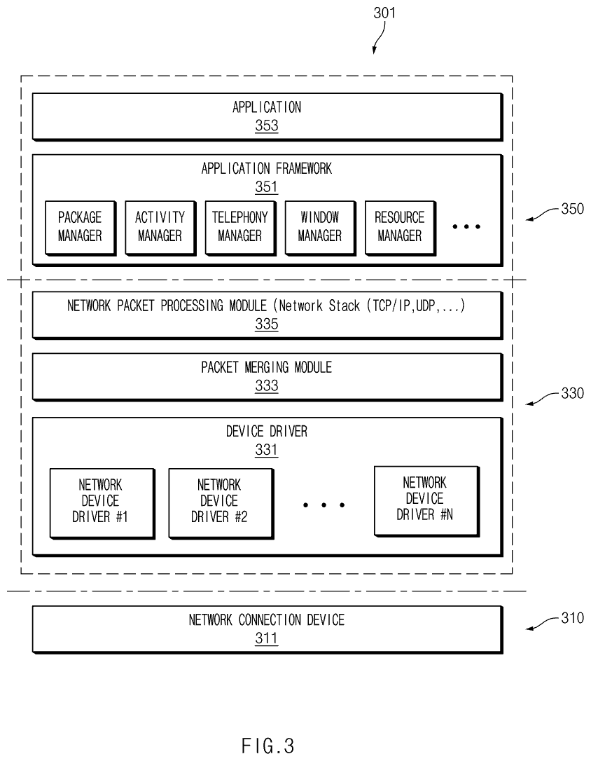

FIG. 3 is a network configuration diagram of an electronic device according to various embodiments. For example, FIG. 3 may represent a hierarchical configuration of an electronic device for processing data packets (e.g., the electronic device 101 in FIG. 1 or the electronic device 201 in FIG. 2).

Referring to FIG. 3, an electronic device 301 (e.g., the electronic device 101 in FIG. 1 or the electronic device 201 in FIG. 2) may include a device layer 310 for transmitting or receiving data packets, a kernel layer 330, and a user layer 350.

According to an embodiment, operations in the device layer 310 may be executed by a communication processor (CP) (e.g., the communication processor 220 in FIG. 2) and/or a communication module (e.g., the communication module 190 in FIG. 1). The kernel layer 330 and the user layer 350 may correspond to a memory address space included in at least a part of a program (e.g., the program 140 in FIG. 1).

According to an embodiment, operations in the kernel layer 330 and the user layer 350 may be executed by a processor (e.g., the processor 120 in FIG. 1). The processor 120 may perform operations (or functions) in the kernel layer 330 and the user layer 350 by executing software 300 (e.g., the program 140 in FIG. 1). Commands related to the operations may be stored in a memory (e.g., the memory 130 in FIG. 1).

According to an embodiment, the device layer 310 may provide the operation of a hardware device for transmitting or receiving data packets. The device layer 310 may include a network connection device 311 (e.g., a network interface controller or Network Interface Cards (NIC) or a modem). According to an embodiment, the network connection device 311 may be a hardware device for converting data packets that the electronic device 301 intends to transmit through a network into a signal or bit string and physically transmitting or receiving the signal or bit string.

According to an embodiment, the kernel layer 330 may be included in an operating system (OS) of the electronic device (e.g., the operating system 142 in FIG. 1). The kernel layer 330 may control the processing of data packets. The kernel layer 330 may include various modules to process received packets. The kernel layer 330 may include a device driver 331, a packet merging module 333, and a network packet processing module 335.

According to an embodiment, the device driver 331 may process the received data packets so that the data packets are capable of being processed in a higher layer. The device driver 331 may process the data packets to conform to the operating system that is being executed on the electronic device 101.

According to an embodiment, the device driver 331 may include one or at least two network device drivers (a network device driver #1, network device driver #2, . . . network device driver #N). The network device drivers may receive packets according to the communication protocol defined by a manufacturer of the network connection device 311.

According to an embodiment, the network device drivers may include device drivers for network devices (e.g., modem, local area network (LAN) card, Bluetooth, near field communication (NFC), Wi-Fi, display, audio, and video).

According to an embodiment, the packet merging module 333 may perform operations related to packet merging. The packet merging module 333 may transmit received packets to a higher layer (e.g., the network packet processing module 335). The packet merging module 333 may transmit structured packets received from the device driver 331 to the higher layer. The packet merging module 333 may merge and transmit the received packets.

An operation related to data packet merging may include an operation of merging consecutive pieces of packet data having at least a part of the same IP/TCP header information into one packet when receiving packets from the network device drivers, and uploading the merged packet to the network packet processing module 335 (e.g., a network stack).

According to an embodiment, the packet merging module 333 may reduce the load of a network packet processing module 355 by merging the received packets and transmitting the merged packet to the higher layer at once. In addition, through the operations related to packet merging, the number of responses (e.g., acknowledge (ACK)) to the received packets may be reduced, thereby reducing the load of the network connection device 311. Data processing efficiency may increase as the overall load within the system decreases.

According to an embodiment, the packet merging module 333 may transmit the received packets directly to a higher layer (e.g., TCP (transmission control protocol)/IP (internet protocol)). When a notification indicating that reception of packets is complete is received or when a specific condition is satisfied, the packet merging module 333 may transmit the received packets directly to the higher layer.

According to an embodiment, in the packet merging module 333, the operation of merging the received packets and transmitting them to the higher layer or directly transmitting the received packets to the higher layer may be referred to as “flush.” “Flush” may refer to an operation of transmitting structures stored in a buffer of the packet merging module 333 to the higher layer.

According to an embodiment, the operation related to packet merging may be referred to as “offload” or “receive offload.” The operation related to packet merging may be performed as a function defined in the OS that is being executed on the electronic device 101. An example of the operation related to packet merging may include generic receiver offload (GRO) in Linux™. Another example of the operation related to packet merging may be receive segment coalescing (RSC) in Windows™.

According to an embodiment, the packet merging module 333 may perform pre-processing to reassemble the data packets received from the network into a relatively larger data packet based on the GRO. Accordingly, a higher TCP layer may process a relatively smaller number of data packets, which may reduce the workload of packet merging at the TCP layer.

For example, a maximum transmission unit (MTU), which is the maximum length of a packet on the network, may generally be set to 1500 bytes, and the GRO may set the maximum length in a header to 16 bits, that is, approximately 65000 bytes. In this case, the maximum number of packets that are possible to be merged on a receiving side may be approximately 45.

When the GRO is appropriately used, CPU resource usage rate and power consumption may be reduced. In this way, the processing efficiency of data packets may be increased, which may improve data transmission speeds. In addition, when TCP ack transmissions are excessive, the transmissions may be reduced. On the other hand, when the GRO is not used appropriately, for example, when the period or size of the GRO becomes excessively large, the number of TCP acks per unit time decreases, which reduces the TCP congestion window growth rate itself, and this may cause the data transmission speed to decrease.

As an aggregation method of bundling multiple packets into a single header by the GRO, a method of: 1) setting a specified period (GRO flush time) to aggregate packets received during the corresponding period, or 2) setting the size of the number of packets to be aggregated in advance and performing aggregation when packets of the corresponding size are received is used.

The TCP Push flag is a value set on a server side in relation to packet merging, and when the TCP Push flag is 1, the packet merging module 333 may immediately transmit all packets currently stored in the buffer to the higher layer.

According to an embodiment, the network packet processing module 335 may process the packets received from the packet merging module 333. The network packet processing module 335 may include a network stack. The network packet processing module 335 may include a network layer (e.g., an Internet protocol (IP), Internet control message protocol (ICMP)) and a transmission layer (a transmission control protocol (TCP) and a user datagram protocol (UDP)).

According to an embodiment, the network packet processing module 335 may receive packets from the network connection device 311 through the device driver 331 and the packet merging module 333. The network packet processing module 335 may process the packets received from the device driver 331 and packet merging module 333 so that they may be processed in the user layer, and then transmit the processed packets to the user layer.

According to an embodiment, the user layer 350 may perform operations using the packets transmitted from the kernel layer 330. In the user layer 350, the transmitted packets may be used to meet the purpose of applications operating in the user layer. For example, the electronic device 101 may display a message or provide a video streaming service, to a user of the electronic device 101. The user layer 350 may include an application framework 351 and an application 353.

According to an embodiment, the application 353 may be run by an operating system (e.g., the operating system 142 in FIG. 1) and/or on the operating system, which controls resources related to the electronic device. The operating system may include, for example, Android™, Linux™, iOS™, Windows™, Symbian™, Tizen™, or Bada™. The application framework 351 may provide functions commonly required by applications 353 or provide various functions to applications 353 that enable the applications 353 to use limited system resources within the electronic device.

According to an embodiment, the application framework 351 may include a package manager, an activity manager, a telephony manager, a window manager, and a resource manager. The package manager may perform tasks such as installing and upgrading programs, for example. The activity manager may, for example, manage execution and termination of applications. The telephony manager may, for example, manage voice calling or video calling functions. The window manager may, for example, manage one or more GUI resources used on the screen. The resource manager may manage, for example, source codes of applications or space in the memory.

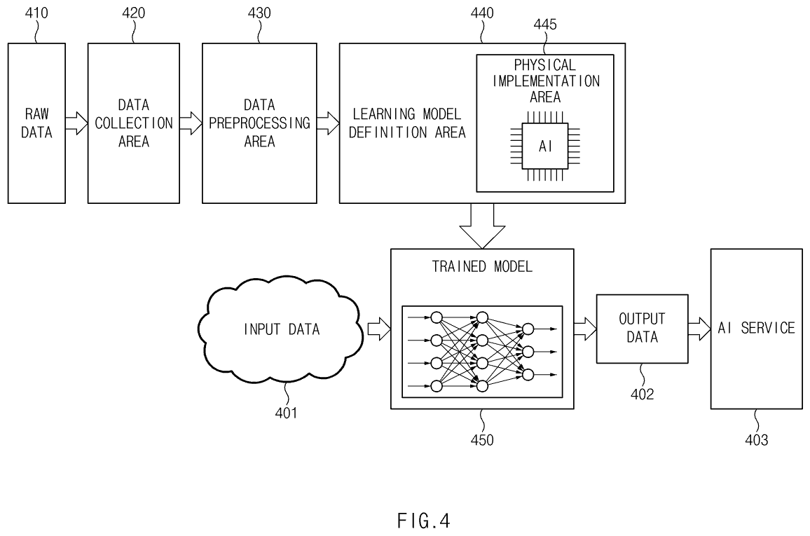

FIG. 4 is a diagram illustrating an example AI model for data packet processing according to various embodiments. FIG. 4 is an example and the disclosure is not limited thereto.

Referring to FIGS. 1 and 4, the processor 120 may generate an AI GRO model 450 related to the merging processing for data packets. The processor 120 may process raw data 410 through a data collection area 420, a data preprocessing area 430, a learning model definition area 440, and a physical implementation area (e.g., including for example an AI processor) 445 to generate an AI GRO model 450.

According to an embodiment, the data collection area 420 may collect the raw data 410 by randomly operating the GRO flush time at an initial point in time. The data preprocessing area 430 may convert the collected raw data 410 into a form that may be processed by the learning model definition area 440.

According to an embodiment, the data preprocessing area 430 may change various factors collected in relation to the merging of data packets, such as a downlink data rate (TP), a signal reception sensitivity (e.g., received signal received power (RSRP)), a round-trip time (RTT), an Internet protocol (IP) type, session information, a network link capacity, application information, server information, a communication band, a bandwidth, and/or a CPU usage rate, into a form that facilitate learning in the learning model definition area 440. For example, the data preprocessing area 430 may convert a congestion window value into a difference value from the previous value to facilitate learning in the learning model definition area 440. For another example, the data preprocessing area 430 may preprocess CPU usage rate information collected from terminals with different CPU structures through an averaging process by CPU type to apply the CPU usage rate information as a feature of the same structure. For still another example, the data preprocessing area 430 may check maximum and minimum values of each feature and normalize them so that the minimum value does not exceed 0 and the maximum value does not exceed 1.

According to an embodiment, the learning model definition area 440 may apply various reinforcement learning techniques to generate the AI GRO model 450. For example, the learning model definition area 440 may apply deep deterministic policy gradient (DDPG) or Batch constrained deep Q-learning (BCQ). DDPG is a reinforcement learning method mainly used in online learning, where a trained model is applied simultaneously with model learning, and BCQ is a reinforcement learning method developed for offline learning, where the model is applied after model learning is complete.

According to an embodiment, the physical implementation area 450 may physically implement the operation of the learning model definition area 440 using neural network elements or circuits, or neuro-processors. The physical implementation area 450 may be at least a portion of a processor (e.g., an AP) within an electronic device (e.g., the electronic device 101 in FIG. 1). According to an embodiment, the AI GRO model 450 may be a model that reflects various factors such as a downlink data rate (TP), a signal reception sensitivity (e.g., received signal received power (RSRP)), a round-trip time (RTT), an Internet protocol (IP) type, session information, a network link capacity, application information, server information, a communication band, a bandwidth, and/or a CPU usage rate using AI machine learning (AI ML) technology.

According to an embodiment, the AI GRO model 450 may receive input data 401 and generate output data 402. The AI service 403 may provide a packet merging related service based on the output data 402. For example, the input data 401 may be features such as a downlink data rate (TP), a signal reception sensitivity (e.g., received signal received power (RSRP)), a round-trip time (RTT), an Internet protocol (IP) type, session information, a network link capacity, application information, server information, a communication band, a bandwidth, and/or a CPU usage rate, which are used in an actual network. The output data 402 may be an algorithm used in relation with packet merging. The AI service 403 may perform packet merging using an artificial intelligence-based algorithm.

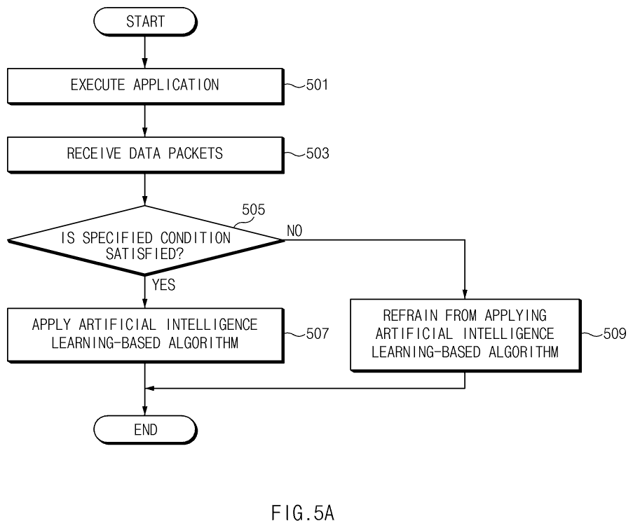

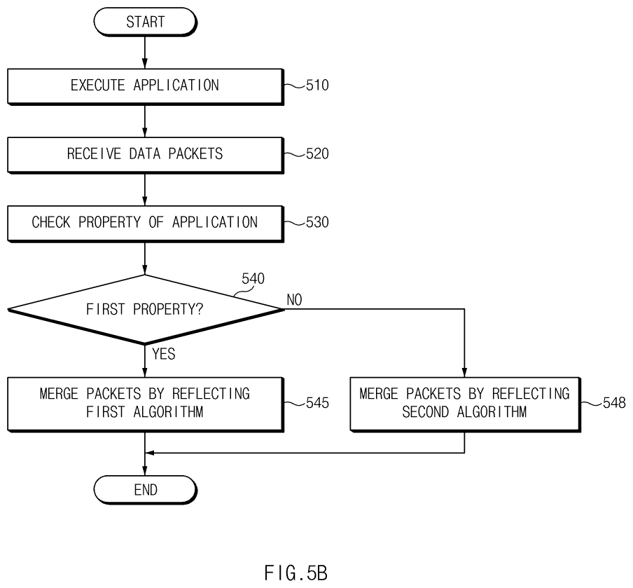

FIG. 5A is a flowchart illustrating an example method for processing a data packet according to various embodiments.

Referring to FIGS. 1 and 5A, in operation 501, the processor 120 may execute an application. The processor 120 may differently apply algorithms related to merging data packets by reflecting traffic characteristics of the data packets received in relation to the application that is being executed.

In operation 503, the processor 120 may receive data packets for an application that is being executed from an external device. Each data packet may include a header and a payload. According to an embodiment, the header of the data packet may include a flag related to merging of data packets. For example, the flag related to merging of data packets may be a TCP Push flag.

According to an embodiment, the TCP Push flag may be set on the server side in relation to the merging processing for data packets on the receiving side. The TCP Push flag may be a flag that causes data to be transmitted immediately to a destination application layer without waiting for the data packet buffer to be filled. The TCP Push flag is mainly used for interactive traffic where fast response is important, and data packets transmitted with the TCP Push flag set to 1 may be immediately transmitted to the application layer, regardless of the period or size of the electronic device of the receiving side applied in the GRO algorithm.

According to an embodiment, the TCP Push flag may be periodically set to 1 on the server side even when transmitting large amounts of data. In this way, it is possible to prevent and/or reduce additional delays due to merging of data packets when there is a significant delay in data transmission due to network conditions or other reasons.

In operation 505, the processor 120 may check (e.g., determine) whether at least one of data throughput information on the external device, state information about a channel transmitting a plurality of data packets, or signal round-trip time information satisfies a specified condition. For example, data throughput information may be downlink data rate (throughput (TP)). The channel state information may be signal reception sensitivity (e.g., received signal received power, (RSRP)). The signal round-trip time information may be a round-trip time (RTT).

According to an embodiment, the specified condition may be set in various ways depending on the network state. For example, the specified condition may be that the downlink data rate (throughput (TP)) is greater than or equal to 1 Mbps.

In operation 507, when the specified condition is satisfied (YES in operation 505), the processor 120 may apply an artificial intelligence learning-based algorithm (AI algorithm) for merging and processing a plurality of data packets to the plurality of data packets. The artificial intelligence learning-based algorithm (AI algorithm) may be an algorithm trained to determine an aggregation level of data packets by reflecting various network characteristics related to the application that is being executed.

According to an embodiment, the artificial intelligence learning-based algorithm may include a first algorithm and a second algorithm.

For example, the first algorithm (PSH1 AI algorithm) may be an algorithm that directly reflects TCP Push flag information included in the headers of the plurality of data packets. The first algorithm (PSH1 AI algorithm) may be an algorithm that immediately transmits the data packets merged so far to the application layer when the TCP Push flag is set to 1. The first algorithm (PSH1 AI algorithm) may be an AI algorithm trained with TCP Push flag information included as a feature.

For example, the second algorithm (PSH2 AI algorithm) may be an algorithm that operates regardless of the TCP Push flag included in the headers of the plurality of data packets. The second algorithm (PSH2 AI algorithm) may be an algorithm that continues to merge data packets until a specified period (e.g., the GRO flush time) ends without immediately transmitting the data packets merged so far to the application layer. The second algorithm (PSH2 AI algorithm) may be an AI algorithm trained without including the TCP Push flag information as a feature.

In operation 509, when the specified condition is not satisfied (NO in operation 505), the processor 120 may refrain from (not apply or limit) applying the artificial intelligence learning-based algorithm for merging and processing the plurality of data packets to the plurality of data packets.

According to an embodiment, the processor 120 may check a property of the application that is being executed and apply the first algorithm or the second algorithm based on the property of the application.

For example, when the application has a first property, the processor 120 may apply the first algorithm to the data packets. The application having the first property may be an application requiring a round-trip time (RTT) within a specified time, or an application requiring a downlink data rate less than or equal to (or below) a specified value.

For another example, when the application has a second property, the processor 120 may apply the second algorithm to the data packets. The application having the second property may be an application that does not require a round-trip time (RTT) within a specified time and requires a downlink data rate greater than (or greater than or equal to) a specified value.

According to an embodiment, the processor 120 may, during a specified period, check a flag that is at least partially included in the plurality of data packets and has a specified value related to merging of the data packets. For example, the flag may be a TCP Push flag.

For example, when the application has the first property, the processor 120 may apply, to the data packets, the first algorithm for merging and processing at least some of the data packets before receiving a data packet corresponding to a flag having a specified value among the data packets.

For another example, when the application has the second property, the processor 120 may apply, to the data packets, the second algorithm for merging and processing at least some of the data packets received among the data packets until a specified period ends. In this case, the processor 120 may refrain from considering the flag having the specified value and apply the second algorithm to the data packets. For example, the specified period may be the GRO flush time.

According to an embodiment, when the application is being executed in a foreground, the processor 120 may apply the artificial intelligence learning-based algorithm (AI algorithm) to the data packets. When the application is being executed in a background, the processor 120 may refrain from applying the artificial intelligence learning-based algorithm (AI algorithm) to the data packets.

According to an embodiment, when the data packets of the application that is being executed are TCP packets, the processor 120 may apply the artificial intelligence learning-based algorithm (AI algorithm) to the data packets. When the data packets of the application that is being executed are not TCP packets, the processor 120 may refrain from applying the artificial intelligence learning-based algorithm (AI algorithm) to the data packets.

FIG. 5B is a flowchart illustrating an example method for processing a data packet according to various embodiments.

Referring to FIGS. 1 and 5B, in operation 510, the processor 120 may execute an application. The processor 120 may differently apply algorithms by reflecting traffic characteristics of the data packets received in relation to the application that is being executed.

Below, when the application is being executed in the foreground, the application of the GRO algorithm is primarily discussed, but the present embodiment is not limited thereto. For example, to an application that is being executed in the background, the AI algorithm may be differently applied depending on a specified condition.

In operation 520, the processor 120 may receive data packets for an application that is being executed in the foreground from an external device. Each data packet may include a header and a payload. The header of the data packet may include a flag related to merging of data packets. For example, the flag related to merging of data packets may be a TCP Push flag.

In operation 530, the processor 120 may check a property of the application.

For example, the processor 120 may classify an application requiring a round-trip time (RTT) (or an application sensitive to RTT) within a specified time (e.g., an interactive application) as a first property. The processor 120 may classify an application requiring a downlink data rate less than or equal to (or less than) a specified value as the first property.

In operations 540 and 545, when the property of the application that is being executed is the first property (YES in 540), the processor 120 may apply a first algorithm for merging and processing the data packets before receiving a packet corresponding to a flag of a first value (e.g., 1). When the processor 120 checks the flag of the first value included in the header of the received packet, the processor 120 may merge packets previously received and stored in the buffer based on the first algorithm and integrate them into one header.

According to an embodiment, the application having the first property may be an application requiring a round-trip time (RTT) within a specified time, or an application requiring a downlink data rate less than or equal to (or below) a specified value.

According to an embodiment, the first algorithm (PSH1 AI algorithm) may be an algorithm that reflects TCP Push flag information as it is and immediately transmits the data packets merged so far to the application layer when the TCP Push flag is set to 1. The first algorithm (PSH1 AI algorithm) may be an AI algorithm trained with TCP Push flag information included as a feature.

According to an embodiment, the processor 120 may generate the first algorithm (PSH1 AI algorithm) by performing AI modeling to maximize and/or increase the downlink data rate (TP) by reflecting the TCP push flag.

According to an embodiment, in operations 540 and 548, when the property of the application that is being executed is not the first property (NO in 540), the processor 120 may apply a second algorithm for merging and processing the received data packets until the period ends. In an embodiment, the application that does not have the first property may be an application that does not require the round-trip time (RTT) within the specified time and requires a downlink data rate greater than (or greater than or equal to) a specified value.

The second algorithm (PSH2 AI algorithm) may be an AI algorithm that operates regardless of the TCP Push flag. The second algorithm (PSH2 AI algorithm) may be an algorithm that continues to merge data packets until the period (e.g., the GRO flush time) ends without immediately transmitting the data packets merged so far to the application layer. The second algorithm (PSH2 AI algorithm) may be an AI algorithm trained without including the TCP Push flag information as a feature.

According to an embodiment, the processor 120 may manage the property of the application that is being executed in the foreground through a separate list (hereinafter, a white list) or analyze the property using a traffic classification algorithm. For example, the processor 120 may determine that the property of the application that is being executed in the foreground is not a first property when the application is stored in the white list. For another example, the processor 120 may analyze and store traffic patterns of an application. The processor 120 may determine that an application requiring a downlink data rate greater than (or greater than or equal to) a specified value does not have the first property according to a traffic pattern.

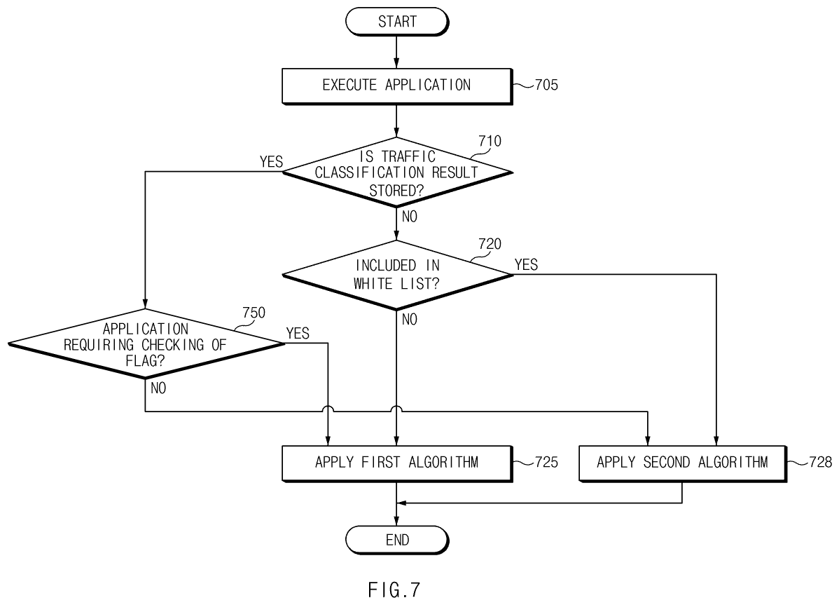

According to an embodiment, the processor 120 may apply the first algorithm or the second algorithm by comprehensively applying the method using the white list and the method using traffic pattern analysis (see, e.g., FIG. 7).

According to an embodiment, the processor 120 may automatically apply the AI algorithm without separate user settings. Alternatively, the processor 120 may display a user interface related to the merging processing for data packets and determine whether to apply the AI algorithm in response to a user input received through the user interface. The processor 120 may display a menu for selectively activating/deactivating only specific algorithms among AI algorithms through a user interface related to the merging processing for data packets.

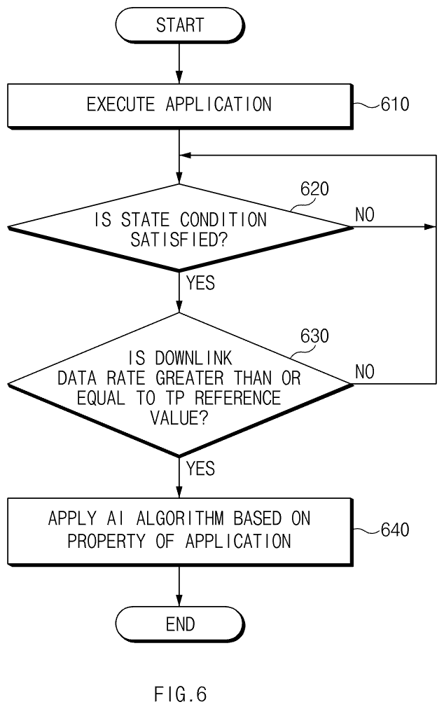

FIG. 6 is a flowchart illustrating example prerequisites for application of an AI algorithm according to various embodiments.

Referring to FIG. 6, in operation 610, the processor 120 may execute an application. For example, the processor 120 may execute an application in a foreground.

In operation 620, the processor 120 may check whether a state condition for operating an AI algorithm is satisfied at each specified period (e.g., 0.5 seconds). For example, the state condition for operating the AI algorithm may be a condition in which the network is in a weak power state (e.g., 100 dBm or lower) or the packets received in relation to the application are TCP packets.

In operation 630, when the state condition is satisfied, the processor 120 may check whether the downlink data rate (TP) is greater than or equal to (or greater than) a specified TP reference value in a previous period. For example, the processor 120 may check whether the TP reference value is greater than or equal to 1 Mbps in each period.

According to an embodiment, when the downlink data rate (TP) is less than (or less than or equal to) the specified TP reference value, since the processor 120 does not need to use the AI algorithm, the algorithm may be turned off to reduce power consumption required to activate and operate the AI learning model.

In operation 640, when the downlink data rate (TP) is greater than or equal to (greater than) the specified TP reference value, the processor 120 may apply an AI algorithm to perform a data packet merging operation for applying different algorithms based on the property of the application in FIG. 5B.

For example, when the application that is being executed in the foreground is not a large-capacity TP or is sensitive to the RTT, the processor 120 may merge and process data packets using the first algorithm trained with the TCP Push flag reflected as a feature. On the other hand, when the application that is being executed in the foreground is a large-capacity TP and is not sensitive to the RTT, the processor 120 may merge and process data packets using the second algorithm trained without reflecting the TCP Push flag as a feature.

According to an embodiment, when the downlink data rate (TP) is less than (or less than or equal to) the specified TP reference value, the processor 120 may apply the AI algorithm according to a specified condition. For example, the specified condition may be determined by reflecting analysis results for user settings or network characteristics.

FIG. 7 is a flowchart illustrating an example method for processing a data packet reflecting a white list or traffic pattern according to various embodiments.

Referring to FIG. 7, in operation 705, the processor 120 may execute an application. For example, the processor 120 may execute the application in a foreground.

In operation 710, the processor 120 may check whether a traffic classification result of the application that is being executed in the foreground is stored. The processor 120 may classify, analyze, and store received traffic when the application is executed. When the application has a short execution time, has no execution history, or has only been executed a small number of times, the traffic pattern and type of the application may not be stored.

In operation 720, when the traffic classification result of the application that is being executed in the foreground is not stored, the processor 120 may check whether the application that is being executed in the foreground is included in a white list. When it is difficult to process data packets reflecting traffic patterns in a state before the traffic pattern and type of the application are stored, the processor 120 may process data packets using the white list.

According to an embodiment, the white list may store identification information about applications that require different AI algorithms to be applied based on the TCP Push flag. The white list may include identification information about applications for which considering only the download rate for each application is advantageous. When the white list is stored, the AI algorithms may be easily applied before the traffic classification result is stored. However, it is difficult to apply merging of data packets for applications not included in the white list, and as the number of applications included in the white list increases, the load on storage capacity and processing may increase.

In operation 725, when the application that is being executed in the foreground is not included in the white list, the processor 120 may apply the first algorithm to merge and process data packets with the first algorithm trained by reflecting the TCP Push flag as a feature until the next period.

In operation 728, when the application that is being executed in the foreground is included in the white list, the processor 120 may apply the second algorithm to merge and process data packets with the second algorithm trained without reflecting the TCP Push flag as a feature until the next period.

In operation 750, when the traffic classification result of the application that is being executed in the foreground is stored, the processor 120 may check whether the application that is being executed is an application requiring checking of a flag related to merging of data packets based on the traffic classification result. The traffic classification result may be stored after a specified time (e.g., one minute) has elapsed since the execution of the application that is being executed in the foreground. The processor 120 may classify the traffic generated for each application using a traffic classification model utilizing an AI learning model.

In operation 725, when the application is an application requiring checking of a flag that is being executed in the foreground, the processor 120 may apply the first algorithm to merge and process data packets with the first algorithm trained by reflecting the TCP Push flag as a feature until the next period.

In operation 728, when the application is an application that does not require checking of the flag that is being execute in the foreground, the processor 120 may apply the second algorithm to merge and process data packets with the second algorithm trained without reflecting the TCP Push flag as a feature until the next period.

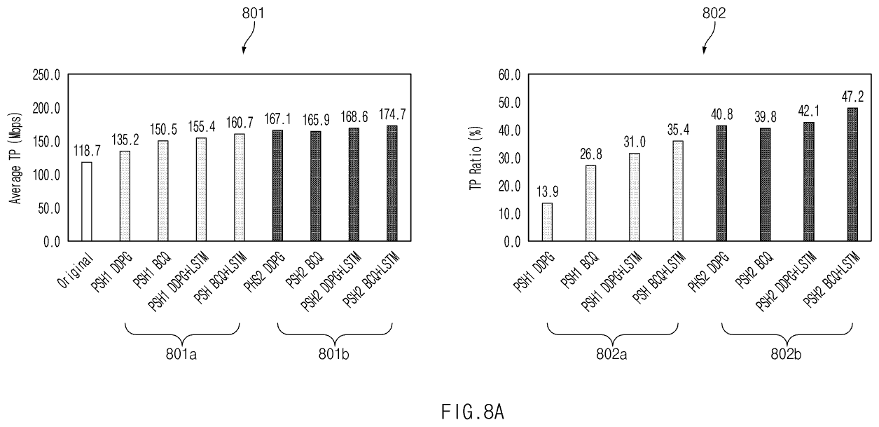

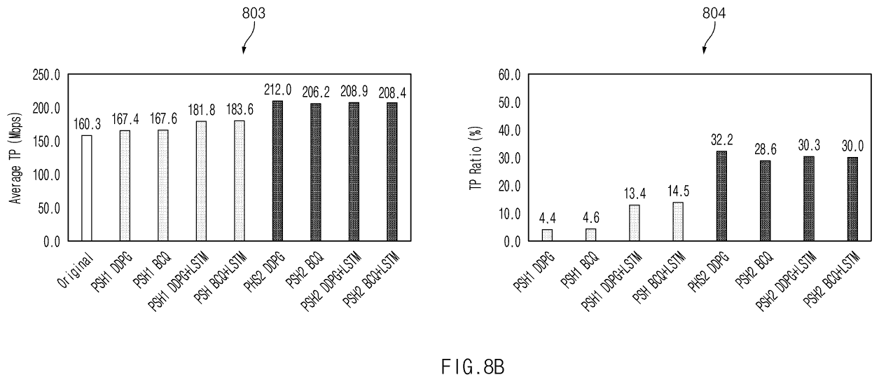

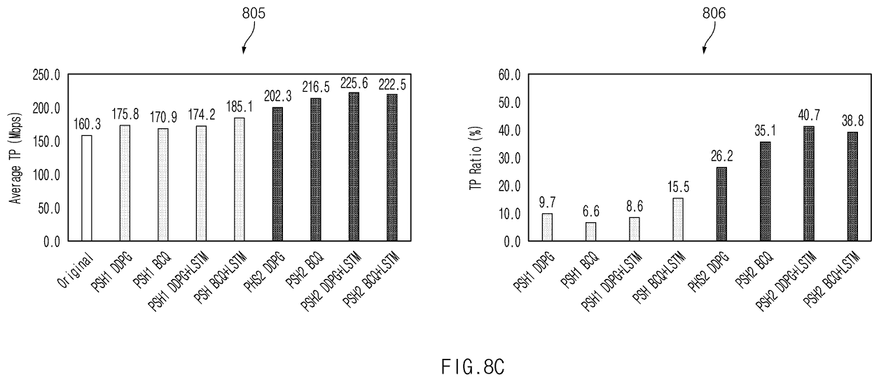

FIGS. 8A, 8B and 8C are graphs illustrating example changes in communication performance according to application of the first algorithm or the second algorithm according to various embodiments.

Referring to FIGS. 1 and 8A, a first graph 801 and a second graph 802 represent the performance of the downlink data rate (TP) of a first portable communication device in a 5G New Radio (NR) weak field environment (−100 dBm or less). The first portable communication device may be a terminal that determines a data packet merging period (GRO flush time) according to a downlink data rate (TP).

The first graph 801 represents an average value of the downlink data rate (TP) for each algorithm for a specified number of times (e.g., 30 times). For example, the first graph 801 represents a 30-time average of the measured downlink data rate (TP) while receiving a 200 Mbyte file from the server.

The second graph 802 represents the rate of increase or decrease in the downlink data rate (TP) when the first algorithm (PSH1) or the second algorithm (PSH2) is applied, compared to when to which the first algorithm (PSH1) or the second algorithm (PSH2) is not applied (original). The increase or decrease rate (TP Ratio) of the downlink data rate (TP) may be calculated as follows.

TP Ratio={(TP in each GRO algorithm-TP of Original GRO method)/(TP of Original GRO method)}*100(%)

In the first graph 801 and the second graph 802, the processor 120 may apply the first algorithm (PSH1) or the second algorithm (PSH2) under various conditions. The first algorithm (PSH1) may be an algorithm based on an AI model trained with the TCP Push flag reflected as a feature. The second algorithm (PSH2) may be an algorithm based on an AI model trained without the TCP Push flag reflected as a feature.

In the first graph 801 and the second graph 802, it may be confirmed that the overall downlink data rate (TP) performance is improved when the first algorithm (PSH1) or the second algorithm (PSH2) is applied (801a, 802a, 801b, 802b) compared to when the first algorithm or the second algorithm is not applied (original). In addition, when the first algorithm (PSH1) (801a, 802a) is applied, the performance improvement is not higher than when the second algorithm (PSH2) (801b, 802b) is applied, but a higher performance improvement may be achieved than when the first or second algorithm is not applied (original).

In addition, the overall performance of downlink data rate (TP) may be improved when the second algorithm (PSH2) is applied (801b, 802b) compared to when the first algorithm (PSH1) is applied (801a, 802a). In communication environments with weak electric fields (−100 dBm or less), application of the second algorithm (PSH2) may be beneficial in improving the performance of downlink data rate (TP). Therefore, the processor 120 may improve the performance of the downlink data rate (TP) using the PSH2 algorithm in the case of applications that do not have restrictions on RTT and require fast transmission speeds.

According to an embodiment, the processor 120 may generate the AI algorithm using various reinforcement learning models. For example, the processor 120 may apply deep deterministic policy gradient (DDPG) or batch constrained deep Q-learning (BCQ). DDPG is a reinforcement learning method mainly used in online learning, where a trained model is applied simultaneously with model learning, and BCQ is a reinforcement learning method developed for offline learning, where the model is applied after model learning is complete. When learning is performed in an offline manner, BCQ may be a more suitable algorithm than DDPG in terms of performance. However, an algorithm of DDPG may require less computation than BCQ. DDPG or BCQ may be applied to the first algorithm (PSH1) or the second algorithm (PSH2), respectively. There may be some differences in the performance of downlink data rate (TP) depending on the communication environment or the like.

According to an embodiment, when the processor 120 uses the reinforcement learning model, learning may become difficult when the number of features becomes too large, and thus, among CP features, RSRQ and SINR may be replaced with other representative features within CP features, such as RSRP and RSSI, and the other representative features are reflected.

According to an embodiment, the processor 120 may generate the AI algorithm by reflecting LSTM. When LSTM is reflected in a neural network model of the reinforcement learning algorithm, information on time series features may be more accurately identified. When reflecting LSTM, the performance of downlink data rate (TP) may be improved somewhat.

Referring to FIG. 8B, a third graph 803 and a fourth graph 804 represent the performance of the downlink data rate (TP) of a second portable communication device in a 5G NR weak electric field environment (−100 dBm or less). The second portable communication device may be a terminal to which both large receive offload (LRO) technology, which is controlled at a hardware level and performs the same function as GRO, and GRO technology at the software level are applied.

The third graph 803 represents an average value of the downlink data rate (TP) for each algorithm for a specified number of times (e.g., 30 times). For example, the first graph 801 represents a 30-time average of the measured downlink data rate (TP) while receiving a 200 Mbyte file from the server.

The fourth graph 804 represents the rate of increase or decrease in the downlink data rate (TP) when the first algorithm (PSH1) or the second algorithm (PSH2) is applied, compared to when the first algorithm (PSH1) or the second algorithm (PSH2) is not applied (original).

In the third graph 803 and the fourth graph 804, the processor 120 may apply the first algorithm (PSH1) or the second algorithm (PSH2) under various conditions. The first algorithm (PSH1) may be an algorithm based on an AI model trained with the TCP Push flag reflected as a feature. The second algorithm (PSH2) may be an algorithm based on an AI model trained without the TCP Push flag reflected as a feature.

Compared to the first graph 801 and the second graph 802 in FIG. 8a, the third graph 803 and the fourth graph 804 may exhibit the improved performance of the overall downlink data rate (TP) due to the application of the LRO technology, but the rate at which the downlink data rate (TP) increases or decreases may be reduced.

According to an embodiment, the processor 120 may generate the AI algorithm using various reinforcement learning models. For example, the processor 120 may apply deep deterministic policy gradient (DDPG) or batch constrained deep Q-learning (BCQ). DDPG or BCQ may be applied to the first algorithm (PSH1) or the second algorithm (PSH2), respectively. There may be some differences in the performance of downlink data rate (TP) depending on the communication environment or the like.

According to an embodiment, the processor 120 may generate the AI algorithm by reflecting LSTM. When LSTM is reflected in a neural network model of the reinforcement learning algorithm, information on time series features may be more accurately identified.

Referring to FIG. 8C, a fifth graph 805 and a sixth graph 806 represent the performance of downlink data rate (TP) measured with LRO of the second portable communication device deactivated in the 5G NR weak field environment (−100 dBm or less).

The fifth graph 805 represents an average value of the downlink data rate (TP) for each algorithm for a specified number of times (e.g., 30 times). For example, the fifth graph 805 represents a 30-time average of the measured downlink data rate (TP) while receiving a 200 Mbyte file from the server.

The sixth graph 806 represents the rate of increase or decrease in the downlink data rate (TP) when the first algorithm (PSH1) or the second algorithm (PSH2) is applied, compared to when the first algorithm (PSH1) or the second algorithm (PSH2) is not applied (original).

Compared to the third graph 803 and the fourth graph 804 in FIG. 8b, the fifth graph 805 and the sixth graph 806 may exhibit lower overall downlink data rate (TP) performance due to the deactivation of the LRO technology, but the rate at which the downlink data rate (TP) increases or decreases may increase in some sections where the second algorithm (PSH2) is applied.

Through FIGS. 8A, 8B and 8C, it may be confirmed that in special network situations such as weak electric fields, when the second algorithm is applied, a TP performance gain of 30% or more on average may be achieved.

According to an embodiment, the processor 120 may apply LRO and the AI algorithm together or deactivate LRO and apply the AI algorithm alone depending on various network environments.

The electronic device merges data packets by applying different GRO periods (e.g., GRO flush time) depending on the IP type (e.g., IPv4 or IPv6) or the downlink data rate (e.g., throughput (TP)). Alternatively, the electronic device keeps the GRO flush time constant regardless of conditions, or uses the LRO technology that is controlled at the HW level but performs the same function as GRO. In this case, various cross-layer perspective factors such as the downlink data rate (TP), signal reception sensitivity (e.g., received signal received power (RSRP)), the round-trip time (RTT), the internet protocol (IP) type, the session information, the network link capacity, the application information, the server information, the communication band, the bandwidth, and/or the CPU usage rate are not reflected in the GRO determination algorithm.

An electronic device according to an embodiment may include a communication circuit, a memory, and at least one processor including a processing circuitry. The memory may store instructions that, when individually or collectively executed by the at least one processor, cause the electronic device to execute an application, determine a property of the application, receive a plurality of data packets for the application from an external device through the communication circuit, check whether at least one of data throughput information on the external device, state information about a channel transmitting the plurality of data packets, or signal round-trip time information satisfies a specified condition, apply artificial intelligence learning-based algorithms for merging and processing the plurality of data packets to the plurality of data packets, when the specified condition is satisfied, and refrain from applying the artificial intelligence learning-based algorithms to the plurality of data packets, when the specified condition is not satisfied.

According to an embodiment, the instructions, when individually or collectively executed by the at least one processor, may cause the electronic device to check a property of the application, apply, to the data packets, a first algorithm among the artificial intelligence learning-based algorithms, when the application has a first property, and apply, to the data packets, a second algorithm different from the first algorithm among the artificial intelligence learning-based algorithms, when the application has a second property.

According to an embodiment, the instructions, when individually or collectively executed by the at least one processor, may cause the electronic device to confirm an application requiring a round-trip time (RTT) to be less than or equal to a specified value as the application having the first property.

According to an embodiment, the instructions, when individually or collectively executed by the at least one processor, may cause the electronic device to confirm an application requiring a downlink data rate to be greater than or equal to a specified value as the application having the first property.

According to an embodiment, the instructions, when individually or collectively executed by the at least one processor, may cause the electronic device to check a flag that is at least partially included in the plurality of data packets and has a specified value related to merging of the data packets, during a specified period, apply, to the data packets, the first algorithm for merging and processing at least some of the data packets before receiving a data packet corresponding to the flag having the specified value among the data packets, when the application has the first property, and apply, to the data packets, the second algorithm for merging and processing at least some of the data packets received among the data packets until the specified period ends, when the application has the second property.

According to an embodiment, the instructions, when individually or collectively executed by the at least one processor, may cause the electronic device to refrain from considering the flag having the specified value and perform an operation of applying the second algorithm to the data packets, when the property is the second property.

According to an embodiment, the instructions, when individually or collectively executed by the at least one processor, may cause the electronic device to apply the artificial intelligence learning-based algorithm to the data packets, when the application is executed in a foreground and refrain from applying the artificial intelligence learning-based algorithm to the data packets, when the application is executed in a background.

According to an embodiment, the instructions, when individually or collectively executed by the at least one processor, may cause the electronic device to apply the artificial intelligence learning-based algorithm to the data packets, when the data packets are TCP packets and refrain from applying the artificial intelligence learning-based algorithm to the data packets, when the data packets are not TCP packets.

An electronic device according to an embodiment may include a communication circuit, a memory, and at least one processor including a processing circuitry. The memory may store instructions, when individually or collectively executed by the at least one processor, cause the electronic device to execute an application, receive a plurality of data packets for the application from an external device through the communication circuit, check a flag that is set in the plurality of data packets and has a specified value related to merging of the data packets, during a specified period, check a property of the application, apply, to the data packets, a first algorithm for merging and processing at least some of the data packets before receiving a data packet corresponding to the flag having the specified value among the data packets, when the application has a first property, and apply, to the data packets, a second algorithm for merging and processing the received data packets until the specified period ends, when the application does not have the first property.

According to an embodiment, the instructions, when individually or collectively executed by the at least one processor, may cause the electronic device to refrain from considering the flag having the specified value and perform an operation of applying the second algorithm to the data packets, when the application does not have the first property.

According to an embodiment, the instructions, when individually or collectively executed by the at least one processor, may cause the electronic device to check the property of the application when the application is executed in a foreground.

According to an embodiment, the instructions, when individually or collectively executed by the at least one processor, may cause the electronic device to check the property of the application when information related to a channel state with the external device satisfies a specified condition.

According to an embodiment, the instructions, when individually or collectively executed by the at least one processor, may cause the electronic device to check the property of the application when a downlink data rate of the application satisfies a specified condition before the period.

According to an embodiment, each of the first algorithm or the second algorithm may be an artificial intelligence model trained based on at least one of data throughput information about the external device, state information about a channel transmitting the plurality of data packets, or signal round-trip time information.

According to an embodiment, the artificial intelligence model may be generated in the external device.

According to an embodiment, the instructions, when individually or collectively executed by the at least one processor, may cause the electronic device to store a list of applications requiring a round-trip time (RTT) to be greater than or equal to a specified value and apply the second algorithm when the application is included in the list.

According to an embodiment, the instructions, when individually or collectively executed by the at least one processor, may cause the electronic device to apply the first algorithm when the application is not included in the list.

According to an embodiment, the instructions, when individually or collectively executed by the at least one processor, may cause the electronic device to confirm an application requiring a round-trip time (RTT) to an external device satisfying a specified condition as the application having the first property.

According to an embodiment, the instructions, when individually or collectively executed by the at least one processor, may cause the electronic device to confirm an application requiring a downlink data rate satisfying the specified condition as the application having the first property.

According to an embodiment, the at least one processor may include an application processor and a communication processor.

An electronic device according to various example embodiments disclosed herein may determine an AI algorithm by considering a TCP Push flag. The electronic device may merge data packets by applying AI algorithms using TCP Push flag information as it is when the application is an application sensitive to RTT. The electronic device may merge data packets by applying AI algorithms that operate regardless of the TCP Push flag when the application is an application that is not sensitive to RTT. In this way, the performance of downlink data rate (TP) may be improved.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit;
memory; and
at least one processor including processing circuitry,
wherein the memory stores instructions that, when individually or collectively executed by the at least one processor, cause the electronic device to:
execute an application;
receive a plurality of data packets for the application from an external device through the communication circuit;
determine whether at least one of data throughput information on the external device, state information about a channel transmitting the plurality of data packets, or signal round-trip time information satisfies a specified condition;
apply artificial intelligence learning-based algorithms to merge and process the plurality of data packets to the plurality of data packets, based on the specified condition being satisfied; and
refrain from applying the artificial intelligence learning-based algorithms to the plurality of data packets, based on the specified condition not being satisfied.

2. The electronic device of claim 1, wherein the instructions, when individually or collectively executed by the at least one processor, cause the electronic device to:
check a property of the application;
apply, to the data packets, a first algorithm among the artificial intelligence learning-based algorithms, based on the application having a first property; and
apply, to the data packets, a second algorithm different from the first algorithm among the artificial intelligence learning-based algorithms, based on the application having a second property.

3. The electronic device of claim 2, wherein the instructions, when individually or collectively executed by the at least one processor, cause the electronic device to confirm an application requiring a round-trip time (RTT) to be less than or equal to a specified value as the application having the first property.

4. The electronic device of claim 2, wherein the instructions, when individually or collectively executed by the at least one processor, cause the electronic device to confirm an application requiring a downlink data rate to be greater than or equal to a specified value as the application having the first property.

5. The electronic device of claim 2, wherein the instructions, when individually or collectively executed by the at least one processor, cause the electronic device to:
check a flag at least partially included in the plurality of data packets and having a specified value related to merging of the data packets, during a specified period;
apply, to the data packets, the first algorithm to merge and process at least some of the data packets before receiving a data packet corresponding to the flag having the specified value among the data packets, based on the application having the first property; and
apply, to the data packets, the second algorithm to merge and process at least some of the data packets received among the data packets until the specified period ends, based on the application having the second property.

6. The electronic device of claim 5, wherein the instructions, when individually or collectively executed by the at least one processor, cause the electronic device to refrain from considering the flag having the specified value and perform an operation of applying the second algorithm to the data packets, based on the property being the second property.

7. The electronic device of claim 1, wherein the instructions, when individually or collectively executed by the at least one processor, cause the electronic device to:
apply the artificial intelligence learning-based algorithm to the data packets, based on the application being executed in a foreground; and
refrain from applying the artificial intelligence learning-based algorithm to the data packets, based on the application being executed in a background.

8. The electronic device of claim 1, wherein the instructions, when individually or collectively executed by the at least one processor, cause the electronic device to:
apply the artificial intelligence learning-based algorithm to the data packets, based on the data packets being TCP packets; and
refrain from applying the artificial intelligence learning-based algorithm to the data packets, based on the data packets not being TCP packets.

9. An electronic device comprising:
a communication circuit;
memory; and
at least one processor including processing circuitry,
wherein the memory stores instructions that, when individually or collectively executed by the at least one processor, cause the electronic device to:
execute an application;
receive a plurality of data packets for the application from an external device through the communication circuit;
check a flag set in the plurality of data packets and having a specified value related to merging of the data packets, during a specified period;
check a property of the application;
apply, to the data packets, a first algorithm to merge and process at least some of the data packets before receiving a data packet corresponding to the flag having the specified value among the data packets, based on the application having a first property; and
apply, to the data packets, a second algorithm to merge and process the received data packets until the specified period ends, based on the application not having the first property.

10. The electronic device of claim 9, wherein the instructions, when individually or collectively executed by the at least one processor, cause the electronic device to refrain from considering the flag having the specified value and perform an operation of applying the second algorithm to the data packets, based on the application not having the first property.

11. The electronic device of claim 9, wherein the instructions, when individually or collectively executed by the at least one processor, cause the electronic device to check the property of the application based on the application being executed in a foreground.

12. The electronic device of claim 9, wherein the instructions, when individually or collectively executed by the at least one processor, cause the electronic device to check the property of the application based on information related to a channel state with the external device satisfying a specified condition.

13. The electronic device of claim 12, wherein the instructions, when individually or collectively executed by the at least one processor, cause the electronic device to check the property of the application based on a downlink data rate of the application satisfying a specified condition before the period.

14. The electronic device of claim 9, wherein each of the first algorithm or the second algorithm comprises an artificial intelligence model trained based on at least one of data throughput information about the external device, state information about a channel transmitting the plurality of data packets, or signal round-trip time information.

15. The electronic device of claim 14, wherein the artificial intelligence model is generated by the external device.

16. The electronic device of claim 9, wherein the instructions, when individually or collectively executed by the at least one processor, cause the electronic device to:
store a list of applications requiring a round-trip time (RTT) to be greater than or equal to a specified value; and
apply the second algorithm based on the application being included in the list.

17. The electronic device of claim 16, wherein the instructions, when individually or collectively executed by the at least one processor, cause the electronic device to apply the first algorithm based on the application not being included in the list.

18. The electronic device of claim 9, wherein the instructions, when individually or collectively executed by the at least one processor, cause the electronic device to confirm an application requiring a round-trip time (RTT) to an external device satisfying a specified condition as the application having the first property.

19. The electronic device of claim 9, wherein the instructions, when individually or collectively executed by the at least one processor, cause the electronic device to confirm an application requiring a downlink data rate satisfying a specified condition as the application having the first property.

20. The electronic device of claim 9, wherein the at least one processor includes:
an application processor comprising processing circuitry; and
a communication processor comprising processing circuitry.
